(19) United States
(12) Patent Application Publication
(10) Pub. No.: US 2021/0053253 A1
(43) Pub. Date: Feb. 25, 2021

(54) ASSEMBLY AND METHOD FOR INJECTING A FLUID INTO MOLTEN POLYMERIC MATERIALS

(71) Applicant: COLORMATRIX HOLDINGS, INC., Wilmington, DE (US)

(72) Inventors: Brian JONES, Knowsley, Merseyside (GB); David WHITEHEAD, Warrington, Merseyside (GB); Ian CAMPBELL, Knowsley, Merseyside (GB); David LOFTUS, Formby, Merseyside (GB); Andrew OVEREND, Bolton, Lancashire (GB)

(21) Appl. No.: 16/979,085

(22) PCT Filed: Feb. 28, 2019
(86) PCT No.: PCT/IB2019/051596

§ 371 Date: Sep. 8, 2020

(30) Foreign Application Priority Data
Mar. 8, 2018 (GB) 1803718.4

(51) Int. Cl. B29B 7/82; B29B 7/60; B29B 7/72; B29B 7/76; B29B 7/94; B29C 48/29; B29C 48/285; B29C 48/385; B29C 48/797; B29C 48/39

(52) U.S. Cl. CPC B29B 7/82; B29B 7/60; B29B 7/726; B29B 7/7621; B29B 7/7636; B29B 7/7647; B29K 2101/12; B29C 48/29; B29C 48/297; B29C 48/385; B29C 48/797; B29C 48/39; B29B 7/94

(57) ABSTRACT

Polymeric Materials An injector (14) for injecting liquid formulation into molten polymer includes a conduit (117) having regions (44, 46) which are secured within a wall of an extruder (19). Conduit (117) includes an annular collar (120) having an upwardly facing annular surface (122) which is arranged to bear against part of a sleeve nut (124). Conduit (117) is arranged within a port (125) which includes a screw-threaded wall (126). The sleeve nut (124) includes a cylindrical body (146) having an inwardly facing cylindrical wall which is arranged to define a cylindrical air gap (148) between itself and an outer wall (147) of conduit (117). Region (150) of the sleeve nut is screw-threadedly engaged in wall (126) of the extruder. In use, cool compressed air is introduced into the assembly in the direction of arrow (170) and it flows through the assembly to cool it.

This invention relates to polymeric materials and particularly, although not exclusively, relates to an assembly for and a method of injecting a fluid, for example a liquid formulation including one or more colourants, into molten polymeric materials.

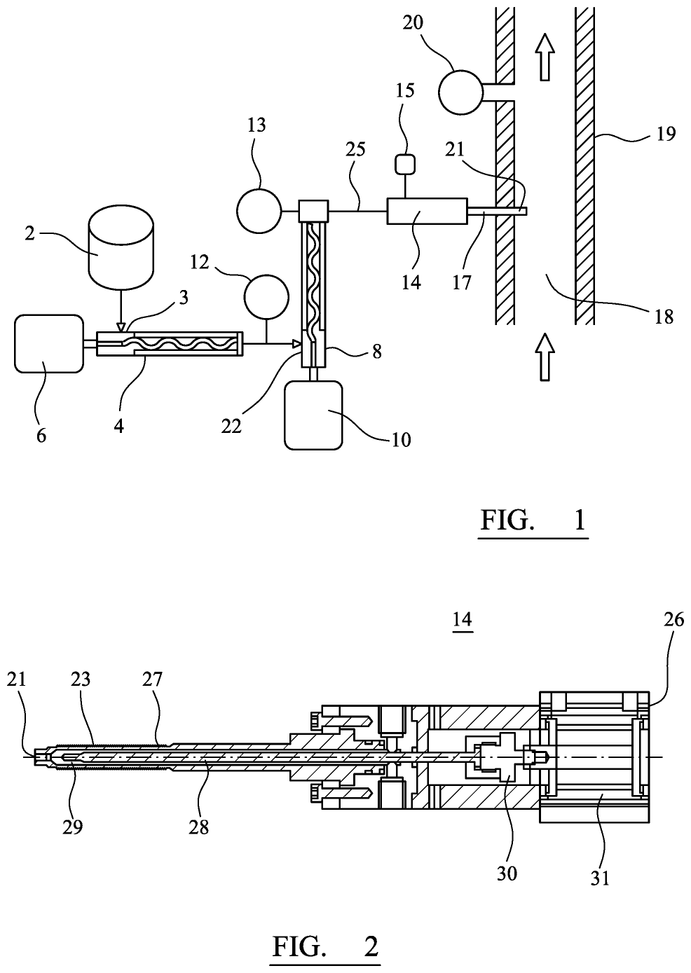

Injection apparatus for injecting a liquid formulation into a molten polymer, at high pressure, is shown in FIG. 1. The apparatus includes a reservoir 2 which contains the liquid formulation at ambient temperature and pressure and is arranged to flood feed pump body 3 of a first progressing cavity pump (pcp) 4. The first pcp 4 is driven by a motor 6 and is arranged to accurately meter the liquid formulation into a second pcp 8 which is downstream of the first pcp, is driven by a motor 10 and is arranged to increase the pressure of the liquid formulation up to 200 bar or more. A pressure transducer 12 is positioned in a flow line between the first and second pcps 4, 8.

Adjacent an outlet of the second pcp 8 is provided a second pressure transducer 13 which is arranged to monitor pressure of fluid exiting the second pcp 8.

Downstream of pump 8 is an injector 14, controlled by an actuator 15 and arranged to control passage of liquid formulation, via conduit 17 and outlet 21, into a pressurized molten polymer stream 18 which is present within an extruder 19 provided downstream of outlet 21. Conduit 17 is screw-threadedly engaged in the wall of the extruder. The extruder includes an associated pressure transducer 20 for monitoring the pressure of the polymer stream.

In use, the apparatus is controlled so the first pcp acts as a metering pump. It is driven to deliver a continuous stream of the liquid formulation accurately and in accordance with the real-time throughput of the polymer in the extruder 19, thereby to accurately delivery liquid formulation, including relevant additives, into the polymer, prior to the polymer being extruded into products such as sheet products, profile products and textile filaments.

Pressure within the pressurized molten polymer stream within the extruder will be significantly greater than the pressure which is deliverable by the first pcp 4. So, when the apparatus is initially operated, injector 14 is closed and therefore isolates the apparatus from the pressurized molten polymer stream. First pcp 4 is operated to meter liquid formulation against inlet 22 of the second pcp 8, with the pressure between first and second pumps 4, 8 being monitored by pressure transducer 12. The pressure is allowed to rise at pressure transducer 12 until a pre-set pressure is achieved. This pre-set pressure is relatively low and is selected to match the preferred discharge pressure capability of pump 4. It is typically 2-3 bar.

Once the pre-set pressure is reached, the second pcp 8 is driven by motor 10 to convey liquid formulation away from pressure transducer 12/inlet 22, while maintaining the pre-set pressure as measured by pressure transducer 12. The speed of motor 10 is continuously adjusted using a proportional-integral-derivative (P.I.D.) loop control to maintain the pre-set pressure at transducer 12 as accurately as possible, since it is found that maintaining a constant and actively controlled discharge pressure of the first pump 4 optimises the metering accuracy of the pump 4.

As pump 8 conveys liquid formulation away from pump 4, pressure is generated within the closed injector 14. The pressure is monitored by second pressure transducer 13. The injector 14 remains closed until the pressure at transducer 13 is equal to or slightly above the pressure of the molten polymer stream in the extruder 19. The pressure of the molten polymer may be assessed by a further pressure transducer 20. Alternatively, the pressure of the polymer may be known for a given set of polymer processing conditions and then programmed into the injection apparatus.

Once the pressure of the liquid formulation at transducer 13 reaches a suitable level (i.e. at or above the pressure of the molten polymer stream), actuator 15 is operated to open injector 14, thereby allowing liquid formulation to flow into the molten polymer stream. Consequently, the pressure of the liquid formulation at transducer 13 will immediately equalise with the pressure of the molten polymer stream in the extruder 19 at the position of injection. During this time, the rotational speed of pump 8 will be modulated as required to maintain the pre-set pressure at transducer 12.

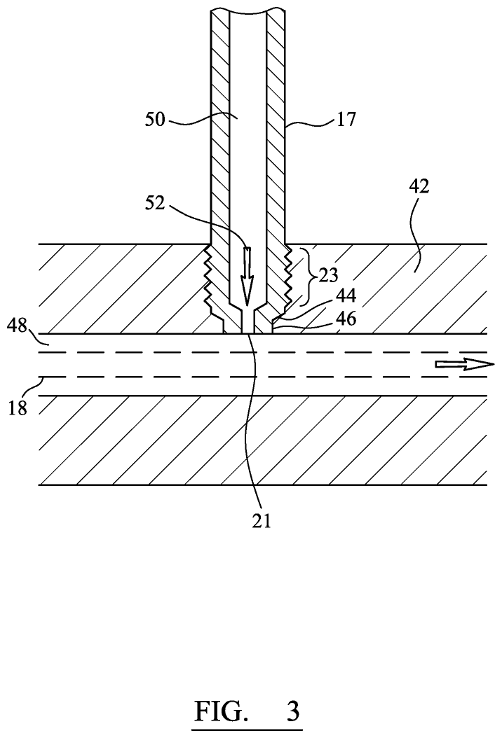

Referring to FIG. 2, the injector 14 may include an externally screw-threaded region 23 adjacent outlet 21 at one end and, at its other end, is arranged to be connected to upstream conduit 25 (FIG. 1) via a coupling housing 26 so that liquid formulation can pass from conduit 25 into the injector.

The injector includes an elongate conduit 27 in which an elongate valve pin 28 having a pointed end 29 is slideably arranged. The pointed end is arranged to extend within outlet 21 so it is capable of expelling all liquid formulation from conduit 27. The pin 28 is operatively connected to an adaptor 30 and pneumatic cylinder 31 which is operable to move pin 28 towards and away from outlet 21 to close/open the outlet and to control ejection of liquid formulation from the injector.

Although the apparatus described in FIGS. 1 and 2 works well for many types of liquid formulations, it has been discovered that when certain liquid formulations, for example including particular vehicles and/or dyes or pigments are used, injector 14 may become blocked. Additionally, blocking of injector 14 is found to be more likely to occur when liquid formulations are being injected into molten polymeric material at relatively low let-down-ratios (LDRs).

A fully blocked (or partially blocked) injector can be highly problematic and must be cleaned. This generally necessitates it being disconnected from the extruder and cleaned. However, prior to disconnection, the pressure of the polymer flowing through the extruder must be reduced and processes downstream of the extruder (e.g. associated with spinning or sheet formation) must be stopped. Then, after cleaning, the injector can be re-connected, polymer pressure in the extruder increased and processes downstream of the extruder re-started. The down-time during cleaning may be 1-2 hours, meaning a significant amount of production of, for example fibre or sheet, can be lost. Given that in, for example spinning, one extruder may feed six to twelve spinning heads, the lost production could be significant.

It is an object of preferred embodiments of the present invention to address the above described problems.

According to a first aspect of the invention there is provided an assembly comprising:
(i) a containing means for a molten polymer;
(ii) apparatus for injecting a fluid formulation into molten polymer contained in the containing means, wherein said apparatus is secured relative to the containing means;
(iii) wherein said apparatus includes an injection device for injecting fluid formulation into molten polymer contained in the containing means;
(iv) wherein said injection device comprises a conduit arranged to deliver fluid formulation into molten polymer in the containing means and a cooling fluid passageway associated with (eg arranged around) the conduit, said cooling fluid passageway being arranged to contain a cooling fluid which is arranged, in use, to cool the conduit and/or a fluid formulation present therewithin.

The cooling fluid is suitably arranged to obviate a potentially detrimental rise in temperature of the conduit and/or a fluid formulation present therewithin.

Said containing means preferably includes a wall (A) which suitably defines a region for containing molten polymer. Said apparatus is preferably secured relative to, more preferably directly to, the wall (A).

Said conduit of said injection device preferably extends within the wall (A). Said conduit preferably extends from a first side of the wall (A) to a second side of wall (A), wherein said first side is an outer wall which suitably is arranged not to contact polymer which may be contained in the containing means in use and said second side defines a volume, for example a passageway, in which polymer is disposed and/or flows in use. Thus, said second side of wall (A) suitably contacts polymer in use.

Said containing means is preferably part of a melt-processing apparatus. Such an apparatus may be for forming the molten polymer into a predetermined shape, for example an extrusion or other moulding. Said containing means into which said apparatus for injecting may inject fluid formulation may be part of, or associated with, an extruder. It may be an extruder channel, or barrel; it may be a mixer in which molten polymer may be arranged, in use, for mixing with the fluid formulation. The mixer may be any dynamic or static mixer, with a cavity transfer mixer being preferred. Said containing means may be part of an injection moulding machine, compression moulding machine, extrusion blow moulding machine or other polymer forming equipment. Said apparatus for injecting may be associated with an extruder, a suitable port within a nozzle, a forming die, a moulding machine shooting pot, a moulding machine transfer valve, an injection mould tool, a compression moulding tool, a machine extruder, a compression moulding machine or a pump, for example a gear pump.

Said conduit preferably includes an opening via which fluid formulation may be injected into molten polymer in the containing means, wherein, preferably, said opening has a mouth which opens directly into a region in said containing means in which molten polymer flows and/or is positioned in use. Thus, said opening in said conduit is preferably aligned with second side of wall (A). Said opening in said conduit preferably has a diameter of at least 2 mm, for example at least 3 mm. The diameter may be less than 8 mm, for example less than 5 mm. The aforementioned diameter suitably refers to the diameter at the narrowest point. Said opening may have a cross-sectional area at its narrowest point in the range 12 mm² to 200 mm², more preferably in the range 12 to 50 mm².

Said conduit preferably includes an outer face which is suitably at an extremity of the conduit and wherein, preferably, said opening via which fluid formulation may be injected into molten polymer extends through the outer face. Said outer face suitably faces in the direction in which fluid formulation is injected out of the apparatus for injecting into said containing means. At least part of (preferably substantially the entirety of) said outer face is preferably contiguous with second side of wall (A).

Preferably, said outer face of said conduit is substantially planar and, preferably, the plane of the outer face is within the same plane as that of the second side of wall (A). Said outer face is preferably annular, suitably with the centre of the annulus defining an opening through which fluid formulation passes in use. Preferably, substantially no step is defined between the outer face of the conduit and the immediately surrounding area defined by the second side of wall (A). The aforementioned arrangement suitably allows the injection device to deliver directly into polymer contained in use in the containing means and/or helps to reduce the risk of blockages.

At an end of said conduit which includes said outer face, the conduit may define a first cylindrical region wherein said first cylindrical region is preferably circularly cylindrical. In the assembly, said first cylindrical region suitably engages (preferably substantially sealingly engages) a corresponding opening in wall (A), for example an opening which is adjacent the second side of wall (A) and/or which opening opens into the passageway in which polymer flows in use. The corresponding opening in wall (A) suitably defines a seat which engages the first cylindrical region.

The end of the conduit which includes said outer face is preferably seated upon a corresponding socket defined in the wall (A), wherein the socket includes an opening adjacent the second side of wall (A) and/or which opening opens into the passageway in which polymer flows in use.

At said end of said conduit which include said outer face, the conduit may include said first cylindrical region and, upstream thereof, a second cylindrical region. Preferably, a step is arranged between the first and second cylindrical regions. Preferably, said second cylindrical region has a larger diameter than the first cylindrical region. There may be a frusto-conical region between the first and second cylindrical regions.

Preferably, the first and second cylindrical regions (and said frusto-conical region if provided) are seated upon walls of said socket defined in the wall (A)

Said first cylindrical region preferably includes substantially smooth walls which are preferably not screw-threaded.

Said second cylindrical region preferably includes substantially smooth walls which are preferably not screw-threaded.

Said frusto-conical region preferably includes substantially smooth walls which are preferably not screw-threaded.

Said conduit preferably is not arranged to be directly screwed into the wall (A). Said conduit preferably does not include any screw-threaded region. Said conduit is preferably not directly screw-threadedly engaged in wall (A). Said conduit preferably does not include any screw-threaded region at all.

As described, preferably said containing means includes a wall (A) which includes a first side and a second side, where said second side defines a passageway in which polymer is disposed and/or flows, in use. Said cooling fluid passageway as described in (iv) above is preferably arranged, at least in part, within wall (A), and suitably extends between first side and second side of wall (A). Said cooling fluid passageway may extend from a first position which is spaced from said first side of wall (A) (and is suitably outside wall (A)) to a second position which is within wall (A) (e.g the passageway is embedded in wall (A)). Said cooling fluid passageway may include an inlet for fluid which is spaced from said first side of wall (A) and, preferably, an outlet for fluid which is also spaced from said first side of wall (A) (and is suitably outside wall (A)).

One wall (referred to as wall W1) of the said cooling fluid passageway is preferably defined, at least in part, by said conduit arranged to deliver fluid formulation into molten polymer. Wall W1 preferably defines an internal wall of the cooling fluid passageway. Said conduit preferably includes a wall having a first surface (e.g. cylindrical surface) which suitably is an internal surface of the conduit and is arranged to contact fluid formulation as it passes through the conduit, prior to injection of the fluid formulation into molten polymer. Said wall of said conduit preferably includes a second surface which suitably is an external surface of the conduit and/or faces outwardly and suitably does not contact the fluid formulation as it passes through the conduit. Said second surface of said wall of said conduit preferably defines at least part of wall W1. The arrangement is preferably such that cooling fluid in the cooling fluid passageway in use directly contacts said conduit of said injection device, for example said second surface of said wall of said conduit as described.

Said second surface of said wall of said conduit may be substantially smooth. Said second surface may be substantially cylindrical or, preferably, is configured to have an increased surface area compared to that of a cylinder. Said second surface preferably includes a series of projections, for example vanes. The projections may be elongate and suitably extend in the direction of flow of cooling fluid through the cooling fluid passageway which is associated with (eg arranged around) the conduit. The projections preferably define a series of flow channels which are preferably elongate. The flow channels may be arranged for passage of cooling fluid from an inlet to an outlet, via a region of the cooling fluid passageway which is embedded within wall (A) of said containing means as described above. Preferably, the flow channels are arranged for passage of cooling fluid from said inlet to said outlet, via a region of the cooling fluid passageway which is at or adjacent an outlet, for example an outer face of said conduit. For example, the flow passageway may come to within a distance of less than 3 cm for example of less than 2 cm from the outer face of said conduit which is suitably at an extremity of the conduit as described. The outer face of the conduit suitably faces into the containing means and/or into molten polymer in the container means in use.

A second wall (referred to as wall W2) of the cooling fluid passageway preferably extends around the conduit. Wall W2 is preferably cylindrical. It is preferably substantially smooth. Wall W2 is suitably arranged to contact cooling fluid in use.

Wall W2 is preferably part of a securement device by means of which the conduit of said injection device is secured, preferably releasably secured, in position. Said securement device preferably comprises a screw-threaded region which is arranged to screw-threadedly engage the containing means, for example wall (A) of said containing means (when provided). Thus, wall (A) of said containing means is preferably screw-threaded for releasably engaging the securement device. Said securement device preferably comprises a sleeve nut, the sleeve of which extends around the conduit and suitably defines wall W2. Said sleeve nut may include a screw-threaded region which has a diameter of at least 10 mm, preferably at least 15 mm, more preferably at least 19 mm. The diameter may be less than 50 mm, less than 40 mm or less than 30 mm.

Said conduit preferably includes a projection, for example a collar, suitably on an outwardly facing surface thereof. The securement device is preferably arranged to contact the collar and apply a force to the projection (and thereby to the conduit) to urge the conduit into sealing engagement with the containing means, for example in wall (A) of said containing means.

The securement device preferably includes an inlet for passage of cooling fluid into said cooling fluid passageway and an outlet for passage of cooling fluid out of the cooling fluid passageway. Said cooling fluid passageway may have a maximum width measured perpendicular to an elongate axis of the conduit of less than 1 cm, for example less than 0.8 cm. The maximum width may suitably be measured midway between an inlet into said passageway and a lowermost end of the passageway which is closest to an opening in said conduit via which fluid formulation is injected, in use, into molten polymer in the containing means.

Said wall W2 is preferably movable between an operative position in which it is secured within wall (A) and defines part of said cooling fluid passageway around the conduit and a second inoperative position wherein it is withdrawn from the operative position. The wall W2 is preferably movable between its operative and inoperative positions, for example in a direction which is parallel to an elongate axis of said conduit of said injection device.

In a preferred embodiment, said apparatus for injecting a fluid formulation comprises said conduit and said securement device (wherein suitable said conduit and securement device are separate and/or separable components), wherein said conduit defines wall W1 of said cooling fluid passageway and said securement device defines wall W2 of said cooling fluid passageway, wherein preferably said cooling fluid passageway is solely defined by the conduit and said securement device and no other component of the apparatus for injecting. Said conduit may be monolithic. Said securement device may be monolithic.

The assembly may include a pipe which is operatively connected to said cooling fluid passageway. Said pipe is preferably connected to a source of cooling fluid. Said cooling fluid herein described is preferably a gas when flowing, in use, within the cooling fluid passageway. Said cooling fluid may comprise compressed air or nitrogen.

Said containing means may contain molten polymer.

Preferably, said polymer comprises a synthetic thermoplastic polymer. Said polymer is preferably able to be formed into fibres. Said polymer may be a condensation polymer, for example a condensation polymer which may depolymerise in the presence of water and/or a carrier with appropriate functional groups (which could include but is not limited to hydroxyl and carboxylic acid species). Said polymer may be selected from polyesters, polyamides, polyalkylene polymers (e.g polypropylene and polyethylene), polycaprolactone, polycarbonates, acrylics and aramids. In one preferred embodiment, said polymer is a polyester.

Said polymer preferably comprises a polyester which may be selected from poly(ethylene terephthalate) (PET), poly(butylene terephthalate) (PBT), poly(trimethylene terephthalate) (PTT), poly(ethylene naphthalate) (PEN), poly(1,4-cyclo-hexylenedimenthylene) terephthalate (PCT), poly(ethylene-co-1,4-cyclohexylenedimethylene terephthalate) (PETG), copoly(1,4-cyclohexylene dimethylene/ethylene terephthalate) (PCTG), poly(1,4-cyclohexylene dimethylene terephthalate-co-isophthalate) (PCTA), poly(ethylene terephthalate-co-isophthalate (PETA), poly(lactic acid (PLA), poly(glycolic acid) (PGA) and their blends of copolymers. Said polymer preferably comprises, more preferably consists essentially of PET.

A typical spinnable condensation polymer such as polyester, for example PET, may have up to 250 or up to 200 repeat units (e.g. molecular weight of up to 25,000 or up to 20,000). The number of repeat units may be in the range 50-200, suitably 75-200, preferably 75-125 repeat units. A typical spinnable polymer may have about 100 repeat units. The condensation polymer may be linear and be able to reach the high levels of orientation and crystallinity which are induced during spinning and drawing processes.

Typical spinnable polyesters have an IV in the range 0.62 to 1 dl/g. Preferred polyesters have an IV within the range of 0.5 to 1.2 dl/g when measured using standard techniques (for example ASTM D4603-03).

Said apparatus may include a receptacle containing a fluid formulation for injection into molten polymer, for example via said injection device.

Said fluid formulation delivered in the method may have a viscosity of at least 5000 cP, suitably at least 10000 cP, preferably at least 15000 cP. The viscosity may be less than 250,000 cP.

Unless otherwise stated, viscosity described herein may be measured using a Brookfield Viscometer at 20 rpm and 20° C.

Said fluid formulation may include vehicle and one or more additives. An additive may be selected from colourants, UV filters, oxygen absorbers, antimicrobial agents, acetaldehyde scavengers, reheat additives, antioxidants, light stabilizers, optical brighteners, processing stabilizers and flame retardants. Said additive preferably includes one or more colourants comprising pigments or dyes. Said fluid formulation preferably includes a pigment

Said fluid formulation may include at least 20 wt %, preferably at least 35 wt %, more preferably at least 50 wt % of additives. Said formulation may include less than 85 wt % of additives. Said fluid formulation may include at least 15 wt % of liquid.

Preferably, said fluid formulation includes at least 20 wt % of colourant which may comprise one or more colourants. The total amounts of colourants in said fluid formulation may be at least 30 wt %, at least 45 wt % or at least 55 wt %. Colourants may be pigments or dyes. Said fluid formulation may include colourants which are insoluble in the vehicle at Standard Temperature and Pressure (STP) which is defined at 0° C. and a pressure of 10⁵ Pa.

Said fluid formulation may include 15 to 80 wt % of vehicle and 20 to 85 wt % of additives.

Said fluid formulation may include a vehicle which is suitably a liquid at STP. Said vehicle preferably has a boiling point (at a pressure of 760 mmHg) of greater than 300° C., preferably greater than 350° C., more preferably greater than 500° C. The boiling point may be less than 1150° C. or less than 1000° C. The melting point of the vehicle may be less than 0° C. or less than −10° C.

In a preferred embodiment, said containing means is an extruder and downstream thereof is a spinning means for spinning molten polymer which has been contacted with fluid formulation. By use of an assembly and/or apparatus as described, the injection of fluid formulation into molten polymer can be accurately controlled (which might otherwise be difficult if there was some partial blockage of the injection device or change in properties of the fluid formulation due to exposure to excessive temperature). Accurate control in the context of formulations used in spinning may be particularly important due to the fact that small changes in such formulations can result in defects in spun fibre, for example leading to breakage of fibre as it is produced.

According to a second aspect of the invention, there is provided a method of injecting a fluid formulation into molten polymer, the method comprising:
(i) selecting an assembly according to the first aspect;
(ii) with molten polymer arranged in said containing means and with cooling fluid arranged in said cooling fluid passageway, operating said injection device to deliver fluid formulation into the molten polymer.

Preferably, the method comprises causing cooling fluid to flow continuously in said cooling fluid passageway during the entirety of the time said injection device is delivering fluid formulation into the molten polymer.

The assembly of the second aspect may include any feature of the assembly of the first aspect.

According to a third aspect of the invention, there is provided a method of assembling an assembly according to the first aspect, the method comprising securing an injection device as described according to the first aspect relative to a containing means as described according to the first aspect.

The method may comprise selecting a conduit as described according to the first aspect and engaging said conduit in an opening, for example socket, defined in a wall (e.g. wall (A) described in said first aspect).

The method may comprise selecting a securement device as described according to the first aspect and using said securement device to releasably secure the conduit in position. The method preferably comprises screw-threadedly engaging the securement device in position, for example within a wall (e.g. wall (A)) of said containing means. The conduit is preferably a sliding fit in a wall (e.g. wall (A)) of said containing means. Said conduit is preferably not secured in said wall (e.g. wall (A)) of said containing means by engagement of any screw-threaded region of said conduit engaging any other screw-threaded region, for example any screw-threaded region defined in a wall (e.g. wall (A)) of said containing means.

The method preferably comprises defining at least part of the cooling fluid passageway arranged to contain cooling fluid by securing the securement device in position, for example around the conduit.

The method may comprise connecting the assembly to a source of molten polymer.

The method may comprise connecting the assembly to a source of cooling fluid.

Any feature of any invention or embodiment described herein may be combined with any other invention described herein mutatis mutandis.

Specific embodiments of the invention will now be described, by way of example, with reference to the accompanying drawings, in which:

FIG. 1 is a schematic representation of apparatus for injecting a liquid formulation into molten polymer;

FIG. 2 is a cross-section through an injector;

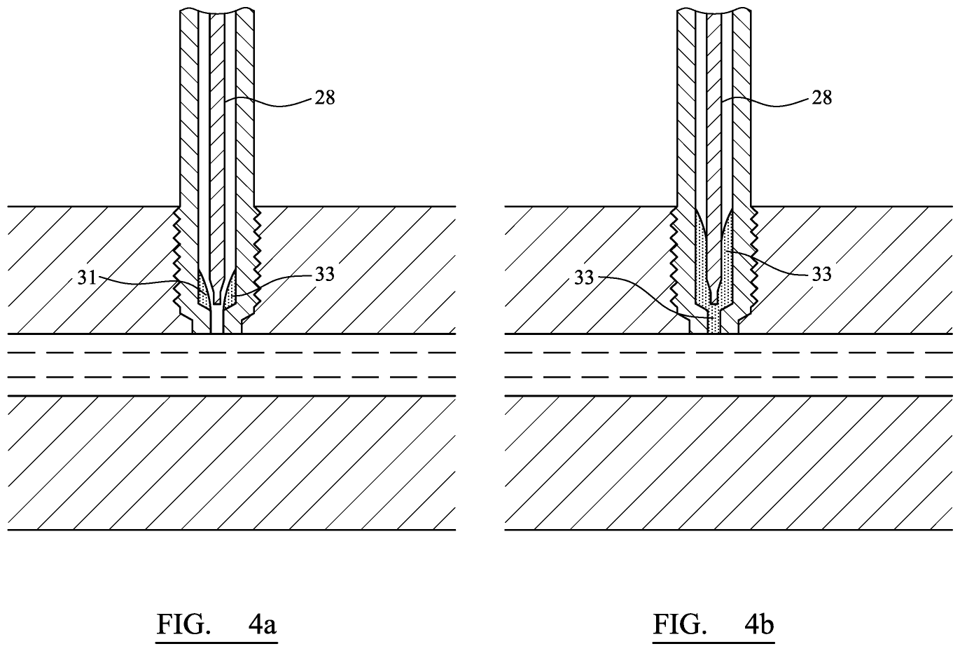

FIG. 3 is a schematic representation of a conduit of an injector of a known apparatus engaged in a wall of an extruder;

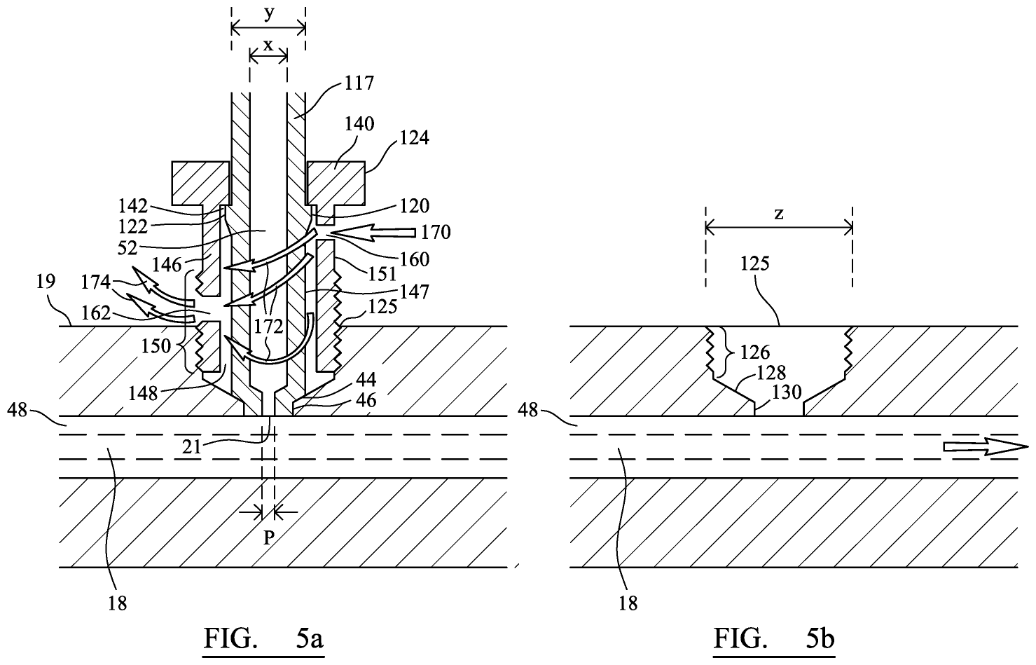

FIGS. 4a and 4b are schematic representations of the conduit of the injector illustrating how the injector becomes blocked;

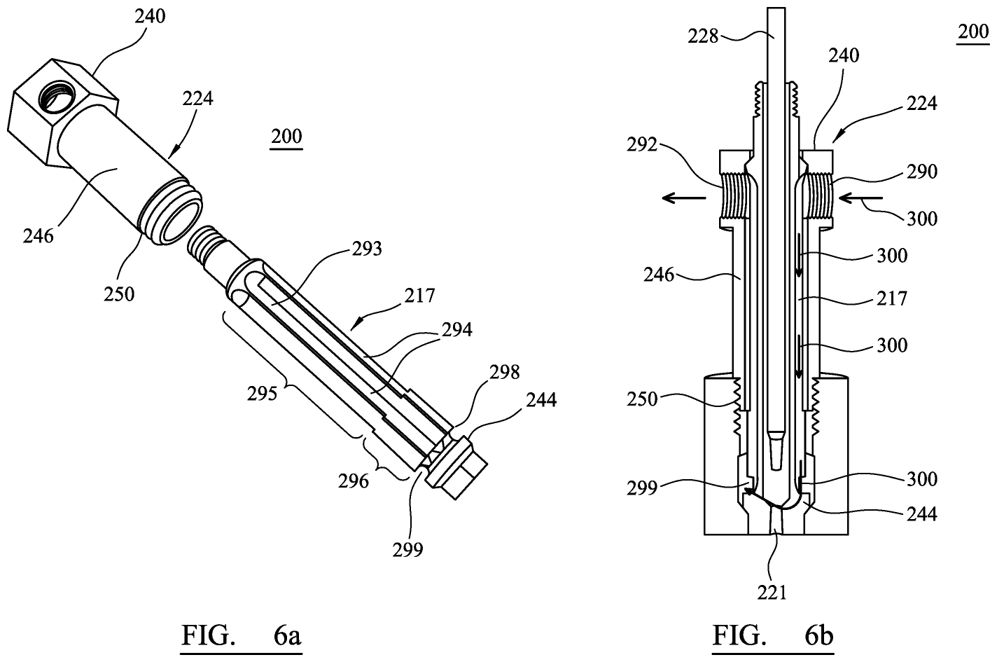

FIG. 5a is a schematic representation of an assembly including a modified conduit of an injector, in accordance with a preferred of embodiment of the invention, engaged in a wall of an extruder;

FIG. 5b is a schematic representation of a wall of the extruder prior to engagement with the assembly of FIG. 5a;

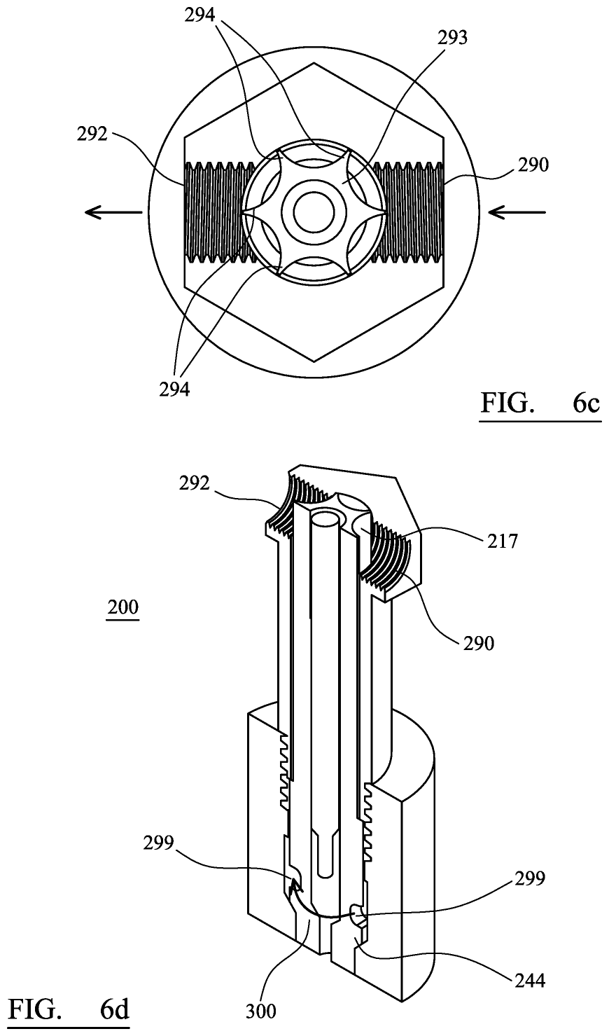

FIG. 6a is a perspective view of a modified assembly for engagement to a wall of an extruder (but excluding a movable pin for opening/closing an outlet of a conduit of the assembly);

FIG. 6b is a schematic cross-section through the assembly of FIG. 6a (but including the movable pin);

FIG. 6c is a cross-section along line VIc-VIc of FIG. 6b; and

FIG. 6d is an isometric view of the modified assembly (including movable pin).

In the figures, the same or similar parts are annotated with the same or similar reference numerals.

The following material is referred to hereinafter:

Formulation A1—a proprietary liquid formulation including vehicle and a red dye.

As described above with reference to FIGS. 1 and 2, injector 14 is arranged to control passage of liquid formulation, via conduit 17 and outlet 21, into pressurized molten polymer stream 18. As shown in FIG. 3, conduit 17 includes outwardly facing, screw-threaded region 23 adjacent outlet 21 via which it can be releasably screw-engaged within a screw-threaded opening defined in metal wall 42 of extruder 19. Downstream of region 23, conduit 17 tapers inwardly to define a frusto-conical region 44 and, downstream thereof, it defines a cylindrical-region 46 in which outlet 21 is defined. Outlet 21 opens into passageway 48 which contains polymer steam 18. The regions 44, 46 are shaped to correspond to a conical seat defined in wall 42 of extruder 19 so the conduit can be tightened down onto the conical seat to prevent leakage of polymer from the extruder. In use, liquid formulation passes within passageway 50 defined in conduit 17 in the direction of arrow 52 towards outlet 21 from which it is injected into the polymer stream 18. A pin (not shown but analogous to pin 28 of FIG. 2) is movable in conduit 17 to close/open outlet 21. The liquid formulation may be injected at pressures which can be in the range 50-200 bar or more.

It is found that, in use, metal wall 42 may be at a temperature of up to about 300° C. by conduction of heat from molten polymer stream 18. In turn, tests have shown that conduit 17 can become heated to substantially the same temperature as the polymer stream. Some liquid formulations are found to be affected by this heating, notably Formulation A1, as described in Example 1 below.

### EXAMPLE 1

A test-rig (not shown) comprises a heated block in which conduit 17 of an injector is screw-engaged in substantially the same manner as that described above with reference to FIG. 3. The temperature of the block can be adjusted, as can the dosing rate of liquid formulation passing through the conduit. In addition, dosing can be stopped for measured periods and restarted, to simulate practical situations.

Liquid formulation A1 was assessed using the test-rig at a relevant dosing rate of 2.92 grams per minute (gpm) (this being equivalent to the lowest likely addition rate in practice) over a range of temperatures. Results of observations are provided in the table below.

| Temp. | |
|---|---|
| (° C.) | Observation |
| 150 | Colourant a very soft paste in the test rig at the specified |
| | temperature. No fuming. No discolouration. No blocking. |
| 175 | Colourant a very soft paste in the test rig at the specified |
| | temperature. No fuming. No discolouration. No blocking. |
| 200 | Colourant appeared a slightly thicker paste in the test rig |
| | at the specified temperature. No fuming. No discolouration. |
| | No blocking. |
| 225 | Colourant caused a blockage on initial opening. Toggling |
| | injector pin freed blockage and dosing acceptable for |
| | remaining 10 minutes. Colourant a thicker paste at the |
| | specified temperature. No fuming. Slight discolouration |
| | (darker). |
| 250 | Colourant caused a blockage on initial opening; which was |
| | freed after toggling injector pin. After 10 minutes there |
| | was a slight pressure rise indicating some blocking |
| | occurring. Colourant thicker and darker in colour. No |
| | fuming. |
| 275 | Colour caused a blockage on initial opening. Toggling |
| | injector pin freed blockage for a short time, but after |
| | 1 minute there was complete blockage. Fuming present. |
| | Very thick paste and dark in colour. |

Thus, it should be appreciated from the above that the formulation described can, disadvantageously, cause blockages in the injector in certain circumstances, for example as it becomes heated to higher temperatures.

In a series of experiments, the reasons why the injector becomes blocked were investigated. As illustrated in FIG. 4a, it was found that, initially, blocking by solid material (illustrated by reference numeral 33), originated on a ledge 31 which defines a seat for valve pin 28. Subsequently, there was a more extensive build-up of solid material resulting in complete blocking of the injector as illustrated by reference numeral 33 in FIG. 4b. Subsequently described embodiments were developed to address the problem of blocking.

A first embodiment of the invention is shown in FIGS. 5a and 5b. Referring to the figures, conduit 117 is similar to conduit 17 of FIG. 3 in that it includes frusto-conical region 44 and cylindrical region 46 which are shaped to correspond to a conical seat defined in wall 42 of extruder 19. However, conduit 117 does not itself include a screw-thread region, for example corresponding to region 23 in FIG. 3.

The conduit 117 includes an annular collar 120 having an upwardly facing (as shown in FIG. 5a) annular surface 122 which is arranged to bear against part of a sleeve nut 124 in use.

The conduit 117 is arranged within a port 125. An opening of port 125 which receives an assembly comprising conduit 117 and sleeve nut 124, is of a wider diameter compared to the diameter of the equivalent port in the FIG. 3 embodiment.

The port 125 includes a wall 126 which is screw-threaded, defining a first cylindrical portion; a wall 128 defining a frusto-conical portion; and a wall 130 defining a second cylindrical portion. The sleeve nut 124 includes a head 140, a lower annular surface 142 of which is arranged to seat upon annular surface 122 of collar 120 of conduit 117. The sleeve nut 124 includes a cylindrical body 146 having an inwardly facing cylindrical wall which is arranged to define a cylindrical air gap 148 between itself and an outer wall 147 of conduit 117. Towards its distal end, in region 150, outer cylindrical wall 151 of the sleeve nut is screw-threaded and arranged to engage screw-threaded wall 126. Sleeve nut 124 also includes an air inlet 160 adjacent head 140 and an air outlet 162. The outlet 162 is offset relative to inlet 160 at approximately 180° about the periphery of cylindrical wall 151 and is axially spaced so outlet 162 extends through screw-threaded region 150 and, in use, is positioned adjacent an outer wall of extruder 19.

Dimensions of elements of assembly of the FIGS. 5a and 5b are as follows:
internal diameter “x” of conduit 117 is about 8 mm.
external diameter “y” of conduit 117 is about 13 mm.
diameter “z” of port 125 is about 22 mm
diameter “p” of outlet 21 is about 3-4 mm.

During assembly, regions 44, 46 of conduit 117 are seated on walls 128, 130 of port 125 with sleeve nut 124 pre-installed on conduit 117, the screw-threaded region 150 is engaged with screw-threaded wall 126 and the nut 124 tightened down to secure conduit 117 in position.

In use, cool compressed air is introduced into the assembly of FIG. 5 in the direction of arrow 170. The air flows within annular air gap 148 as illustrated by arrows 172, thereby cooling conduit 117 (and liquid formulation therein). The heated air then passes out of the assembly via outlet 162 as illustrated by arrows 174.

The assembly 200 of FIGS. 6a-6d is similar to that of FIGS. 5a and 5b. Assembly 200 includes a sleeve nut 224 which includes a head 240, a cylindrical body 246 and a region 250 which is screw-threaded and arranged to engage screw-threaded wall 126 (FIG. 5b) as described for the FIGS. 5a and 5b embodiment.

Head 240 includes an inlet 290 for compressed air and, diametrically opposed thereto, an outlet 292 (not shown in FIG. 6a but shown in FIGS. 6b and 6c).

Conduit 217 is modified compared to conduit 117 of FIGS. 5a and 5b. In this regard, the conduit 217 includes a central hollow hub 293 from which a series of elongate, radially-extending vanes 294 project. In FIG. 6c, six vanes 294 are illustrated, spaced apart at 60° around the hub 293.

Each vane 294 includes a step (along its elongate extent). Thus, each vane 294 includes a first thickness (measured radially) along a first portion 295 of its length and a second, wider thickness along a second portion 296 of its length. The increased thickness is arranged to fill a wider gap existing below nut 224 when the assembly 200 is fully assembled.

The vanes 294 co-operate to define passageways for compressed air. The passageways are defined between an outer surface of the conduit 217 and inwardly facing cylindrical wall 297 of cylindrical body 246 of sleeve nut 224. Beyond the distal ends 298 of the vanes an annular gap 299 is defined, the gap being defined inwards of annular region 244 of the conduit 217.

FIGS. 6b to 6d also include pin 228 which is movable within an elongate cylindrical opening in conduit 217 to close/open outlet 221.

In use, the assembly 200 is engaged in a port 125 as described for the FIGS. 5a and 5b embodiment. Then a compressed air supply is connected to inlet 290 and, in use, air is injected into the assembly. The air passes into the assembly as illustrated by arrows 300 in FIGS. 6b and 6c. It passes down passageways defined by vanes 294 and through gap 299. Thereafter, the air passes up passageways defined by vanes 294 and out of the assembly via outlet 292. The arrangement of the vanes 294, gap 299, inlet 290 and outlet 292 promotes the flow of the air towards and away from outlet 221. Consequently, heat is removed from regions of the conduit 117 which are expected to become hottest and/or which are close to regions of the conduit which are found, as described with reference to FIGS. 4a and 4b, to be where blockages of the conduit start.

The apparatus of FIGS. 5 and 6 were tested as described in Examples 2 and 3.

### EXAMPLE 2

Using the test-rig described in Example 1, the apparatus of FIGS. 5 and 6 were assessed over a range of different compressed air flow rates. Results are provided in the table below.

| | |
|---|---|
| Air flow rate | Temperature adjacent injector tip (° C.) |

| (litres/minute) | Embodiment of FIG. 5 | Embodiment of FIG. 6 |
|---|---|---|
| No air | 277 | 274 |
| 10 | 266 | 252 |
| 20 | 254 | 228 |
| 30 | 252 | 213 |

The results illustrate the preference to use air to cool the tip and that the embodiment of FIG. 6 is improved relative to that of FIG. 5.

### EXAMPLE 3

The apparatus of FIGS. 5 and 6 was assessed, over a range of dosing rates, whilst injecting Formulation A1 into polymer in an extruder. In FIGS. 5 and 6, the air flow rate was litres/minute. Results are provided in the table below.

| | |
|---|---|
| Dosing rate of | |
| Formulation A-1 | Results |

| (grams per minute of | Embodiment | Embodiment |
|---|---|---|
| formulation delivered) | of FIG. 5 | of FIG. 6 |
| 2.91 | No blockage | No blockage |
| 0.73 | Instant blockage | 20 minutes with |
| | | one small blockage |

Given that the lowest expected dosing rate of formulation A-1 in a production environment is approximately 2.92 grams per minute, both the embodiments of FIGS. 5 and 6 would be suitable for commercial use. For lower dose rates, the embodiment of FIG. 6 is preferred and/or the air flow rate may be increased.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An assembly comprising:
(i) a containing means for molten polymer;
(ii) apparatus for injecting a fluid formulation into molten polymer contained in the containing means, wherein said apparatus is secured relative to the containing means;
(iii) wherein said apparatus includes an injection device for injecting fluid formulation into molten polymer contained in the containing means;
(iv) wherein said injection device comprises a conduit arranged to deliver fluid formulation into molten polymer in the containing means and a cooling fluid passageway associated with the conduit, said cooling fluid passageway being arranged to contain a cooling fluid which is arranged, in use, to cool the conduit and/or a fluid formulation present therewithin.

2. An assembly according to claim 1, wherein said containing means includes a wall (A) which defines a region for containing molten polymer, wherein said conduit of said injection device extends within the wall (A), wherein said containing means is part of a melt-processing apparatus and wherein said conduit extends from a first side of wall (A) to a second side of wall (A), wherein said second side defines a passageway in which polymer is disposed and/or flows in use, wherein said conduit includes an opening via which fluid formulation is injected, in use, into molten polymer in the containing means, wherein said opening has a mouth which opens directly into a region in said containing means in which molten polymer flows and/or is positioned in use.

3. (canceled)

4. An assembly according to claim 3, wherein said opening in said conduit is aligned with said second side of wall (A) and said opening preferably has a cross-sectional area at its narrowest point in the range 12 mm² to 200 mm².

5. An assembly according to claim 3, wherein said conduit includes an outer face which is at an extremity of the conduit and wherein said opening via which fluid formulation is injected, in use, into molten polymer extends through the outer face, wherein at least part of said outer face is contiguous with second side of wall (A).

6. An assembly according to claim 3, wherein said conduit includes an outer face which is at an extremity of the conduit and wherein said opening via which fluid formulation is injected, in use, into molten polymer extends through the outer face, wherein substantially no step is defined between the outer face of the conduit and the immediately surrounding area defined by the second side of wall (A).

7. An assembly according to claim 3, wherein said conduit includes an outer face which is at an extremity of the conduit and wherein said opening via which fluid formulation is injected, in use, into molten polymer extends through the outer face, wherein at an end of said conduit which includes an outer face, the conduit defines a first cylindrical region which engages a corresponding opening in a wall (A) which defines a region of said containing means for containing molten polymer;
wherein an end of the conduit which includes an outer face thereof is seated upon a corresponding socket defined in the wall (A), wherein the socket includes an opening adjacent a second side of wall (A) and/or which opening opens into the passageway in which polymer flows in use;
wherein at said end of said conduit which includes said outer face, the conduit includes said first cylindrical region and, upstream thereof, a second cylindrical region, wherein a step is arranged between the first and second cylindrical regions; and
wherein, optionally, the first and second cylindrical regions are seated upon walls of said socket defined in the wall (A).

8. (canceled)

9. An assembly according to claim 1, wherein said conduit is not arranged to be directly screwed into a wall (A) of said containing means, wherein wall (A) defines a region of said containing means for containing molten polymer.

10. An assembly according to claim 1, wherein said containing means includes a wall (A) which includes a first side and a second side, where said second side defines a passageway in which polymer is disposed and/or flows, in use, wherein said cooling fluid passageway is arranged, at least in part, within wall (A), and extends between said first side and second side of wall (A), wherein said cooling fluid passageway extends from a first position which is spaced from said first side of wall (A) to a second position which is within wall (A).

11. An assembly according to claim 1, wherein one wall W1 of the said cooling fluid passageway is defined, at least in part, by said conduit arranged to deliver fluid formulation into molten polymer, wherein wall W1 defines an internal wall of the cooling fluid passageway.

12. An assembly according to claim 11, wherein said conduit includes a wall having a first surface which is an internal surface of the conduit and is arranged to contact fluid formulation as it passes through the conduit prior to injection of the fluid formulation into molten polymer and said conduit includes a second surface which is an external surface of the conduit and/or faces outwardly and does not contact the fluid formulation as it passes through the conduit, wherein the arrangement is such that cooling fluid in the cooling fluid passageway in use directly contacts said second surface of said wall of said conduit.

13. An assembly according to claim 12, wherein said second surface of said wall of said conduit includes a series of projections which are elongate and extend in the direction of flow of cooling fluid through the cooling fluid passageway, wherein the projections define a series of flow channels.

14. An assembly according to claim 12, wherein a second wall W2 of the cooling fluid passageway extends around the conduit and is arranged to contact cooling fluid in use, wherein wall W2 is part of a securement device by means of which the conduit of said injection device is secured in position.

15. An assembly according to claim 14, wherein said wall W2 is movable between an operative position in which it is secured within wall (A) and defines part of said cooling fluid passageway around the conduit and a second inoperative position wherein it is withdrawn from the operative position.

16. An assembly according to claim 14, wherein said securement device comprises a screw-threaded region which is arranged to screw-threadedly engage the containing means.

17. An assembly according to claim 14, wherein the securement device includes an inlet for passage of cooling fluid into said cooling fluid passageway and an outlet for passage of cooling fluid out of the cooling fluid passageway.

18. An assembly according to claim 14, wherein said apparatus for injecting a fluid formulation comprises said conduit and said securement device, wherein said conduit defines wall W1 of said passageway and said securement device defines wall W2 of said passageway, wherein preferably said passageway is solely defined by the conduit and said securement device and no other component of the apparatus for injecting.

19. An assembly according to claim 1, wherein the assembly includes a pipe which is operatively connected to said cooling fluid passageway and said pipe is connected to a source of cooling fluid; and said containing means contains molten polymer; and/or
wherein said apparatus includes a receptacle containing a fluid formulation for injection into molten polymer via said injection device; and/or
wherein said containing means is an extruder and downstream thereof is a spinning means for spinning molten polymer which has been contacted with fluid formulation.

20. (canceled)

21. (canceled)

22. An assembly according to claim 1, wherein said fluid formulation delivered in the method has a viscosity of at least 5000 cP and less than 250,000 cP, includes an additive which comprises one or more colourants comprising pigments or dyes and includes 15 to 80 wt % of vehicle and 20 to 85 wt % of additives.

23. A method of injecting a fluid formulation into molten polymer, the method comprising:
(i) selecting an assembly according to claim 1,
(ii) with molten polymer arranged in said containing means and with cooling fluid arranged in said cooling fluid passageway, operating said injection device to deliver fluid formulation into the molten polymer; wherein the method comprises causing cooling fluid to flow continuously in said cooling fluid passageway during the entirety of the time said injection device is delivering fluid formulation into the molten polymer.

24. (canceled)

25. (canceled)

26. An assembly comprising:
(i) a containing means for molten polymer;
(ii) apparatus for injecting a fluid formulation into molten polymer contained in the containing means, wherein said apparatus is secured relative to the containing means;
(iii) wherein said apparatus includes an injection device for injecting fluid formulation into molten polymer contained in the containing means;
(iv) wherein said injection device comprises a conduit arranged to deliver fluid formulation into molten polymer in the containing means and a cooling fluid passageway associated with the conduit, said cooling fluid passageway being arranged to contain a cooling fluid which is arranged, in use, to cool the conduit and/or a fluid formulation present therewithin;
wherein one wall W1 of the said cooling fluid passageway is defined, at least in part, by said conduit arranged to deliver fluid formulation into molten polymer, wherein wall W1 defines an internal wall of the cooling fluid passageway;
wherein said conduit includes a wall having a first surface which is an internal surface of the conduit and is arranged to contact fluid formulation as it passes through the conduit prior to injection of the fluid formulation into molten polymer and said conduit includes a second surface which is an external surface of the conduit and/or faces outwardly and does not contact the fluid formulation as it passes through the conduit, wherein the arrangement is such that cooling fluid in the cooling fluid passageway in use directly contacts said second surface of said wall of said conduit;
wherein said second surface of said wall of said conduit includes a series of projections which are elongate and extend in the direction of flow of cooling fluid through the cooling fluid passageway, wherein the projections define a series of elongate flow channels.
